(19) United States
(12) Patent Application Publication
(10) Pub. No.: US 2015/0125110 A1
(43) Pub. Date: May 7, 2015

(54) Passively Placed Vertical Optical Connector

(71) Applicant: Cisco Technology, Inc., San Jose, CA (US)

(72) Inventors: Sean Philip Anderson, Macungie, PA (US); Vipulkumar Patel, Breinigsville, PA (US); David Piede, Allentown, PA (US)

(73) Assignee: Cisco Technology, Inc., San Jose, CA (US)

(21) Appl. No.: 14/070,962

(22) Filed: Nov. 4, 2013

(51) Int. Cl. G02B 6/122; G02B 6/136; G02B 6/13

(52) U.S. Cl. CPC G02B 6/122; G02B 6/13; G02B 6/136; G02B 2006/12176
USPC 385/14; 29/428

(57) ABSTRACT

An optical integrated circuit (IC) is provided that includes a waveguide to propagate light in the IC. A diffractive element, such as a grating, couples light between the waveguide and an external optical connector. At least one alignment feature is lithographically formed in the optical IC to facilitate precise positioning of the optical connector on the optical IC. Since the alignment feature is lithographically formed in a precise relation to the diffractive element, the optical connector can be accurately positioned and optically coupled to the optical IC. Complex optical-feedback-based alignment equipment and operations to achieve optical coupling of the optical connector with the waveguide in the optical IC are not necessary.

### TECHNICAL FIELD

The present disclosure relates to making connections to optical integrated circuits.

### BACKGROUND

Efficiently coupling light from an optical integrated circuit (IC) into an optical fiber is a significant challenge due to the extremely small scale size of optical modes or light beams in the optical IC. The high precision that may be required for low-loss coupling can lead to increased manufacturing time, cost, and complexity. Sub-micron alignment is not normally achievable with passive alignment. Additionally, in-plane connectors take up valuable “floor” space in an optical package due to both their physical size and the need for some finite travel distance to allow for proper alignment.

A vertically-aligned connector saves significant space in the package. An optical grating can be used as the basis for vertical coupling, although gratings do not generally achieve perfect vertical coupling, as their optimal coupling occurs at some angle relative to normal. This angle is a function of wavelength, and may also vary due to fabrication tolerances of the grating, making passive alignment challenging.

### BRIEF DESCRIPTION OF THE DRAWINGS

FIG. 1A is a side view of an optical integrated circuit (IC) according to one example and having lithographically defined holes to facilitate alignment with an optical connector.

FIG. 1B is a top view of the optical IC with the lithographically defined holes for mating with the optical connector according to the example shown in FIG. 1A.

FIG. 2 is a side view of an optical IC and illustrating on a diffractive element, prism, and the light path between a waveguide in the optical IC and the optical connector.

FIG. 3A is a side view of an optical IC according to another example and having lithographically formed posts with ledges configured to support the optical connector.

FIG. 3B is a top view of the optical IC having lithographically formed posts with ledges according to the example of FIG. 3A.

FIG. 4A is a side view of an optical IC according to yet another example and having a lithographically formed wall configured to achieve alignment with the optical connector.

FIG. 4B is a top view of the optical IC having two lithographically formed walls that create a corner abutment according to the example of FIG. 4A.

FIG. 5 is a side view of an optical IC according to still another example and having a turning mirror to direct a light beam in alignment with a horizontally oriented optical fiber.

FIG. 6 is a side view of an optical IC and an optical connector in which a prism is disposed on the optical connector in order to achieve light beam alignment with a waveguide in the optical IC.

FIG. 7 is a side view of an optical IC with an additional lithographically formed alignment feature for a prism.

FIG. 8 is a flowchart of an example process for manufacturing an optical IC configured with the alignment features presented herein.

FIG. 9 is a flowchart of an example process of aligning an optical connector with an optical IC configured with the alignment features presented herein.

### DESCRIPTION OF EXAMPLE EMBODIMENTS

### Overview

An optical integrated circuit (IC) is provided that includes a waveguide to propagate light in the IC. A diffractive element, such as a grating, couples light between the waveguide and an external optical connector. At least one alignment feature is lithographically formed in the optical IC to facilitate precise positioning of the optical connector on the optical IC. Since the alignment feature is lithographically formed in a precise position/relationship to the diffractive element, the optical connector can be accurately positioned and optically coupled to the optical IC. Complex optical-feedback-based alignment equipment and operations to achieve optical coupling of the optical connector with the waveguide in the optical IC are not necessary.

### Example Embodiments

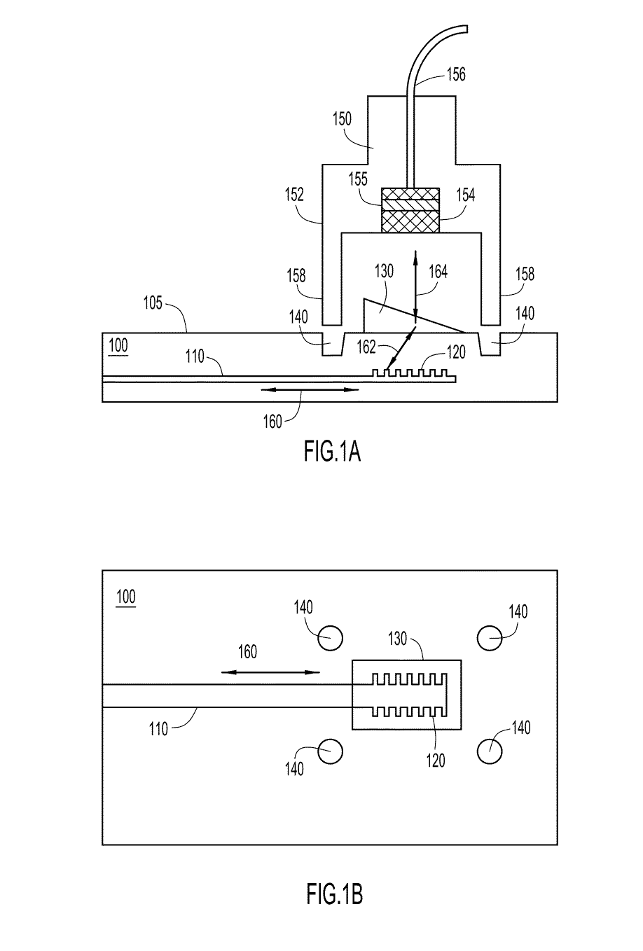

Referring first to FIGS. 1A and 1B, an optical IC having alignment features in the form of lithographically created holes according to one example is described. Optical IC 100 has a top surface 105 and comprises waveguide 110 and diffractive element 120. The diffractive element 120 is, for example, an optical grating. A refractive element 130, such as a prism, may be located over the diffractive element 120. Optical IC 100 also includes at least one alignment feature or structure that, in this example, comprises holes 140 into which a portion of an optical connector 150 fits or mates.

Optical connector 150 comprises housing 152 that holds optics 154 and optical fiber 156 in place. Housing 152 may additionally comprise posts 158 that are configured to mate with an alignment feature such as holes 140. The optics 154 may comprise collecting optics and/or focusing optics, depending on the specific design and purpose of the optical IC. In one example, optics 154 includes an optical isolator 155 configured to reduce back reflections from the optical fiber 156. As described herein, the at least one alignment feature is positioned in a predetermined relationship (location) on the optical IC with respect to the diffractive element 120 to achieve a desired alignment of the diffractive element 120 with respect to the optical connector 150. For example, the at least one alignment feature is formed a predetermined distance away from the diffractive element 120, the predetermined distance being determined or based on the dimensions and structure configuration of housing 152 of the optical connector 150.

FIG. 1B shows the top view of optical IC 100 in which the alignment feature consists of four circular holes 140. Alternatively, more or fewer than four holes may be used as an alignment feature. Holes 140 may also be non-circular in outline (e.g., rectangular, hexagonal, elongated trenches, indentations, etc.) and may have a chamfer to assist in placing the mating optical connector. Optical connector 150 may additionally include posts 158 with a chamfer to assist in placing posts 158 in holes 140.

In one example, waveguide 110 is part of a photonic circuit that may include light generating elements (e.g., lasers, light emitting diodes, etc.) and/or light responsive elements (e.g., photo detectors, optical modulators, etc.). The photonic circuit may be based in part on silicon, gallium arsenide, or other suitable semiconductor material. The additional light generating elements may direct light into waveguide 110 to couple light off of optical IC 100. Light responsive elements may receive light from waveguide 110 that has been coupled from off of optical IC 100 through the optical connector 150.

In operation, light beam 160 travels through waveguide 110 until it impinges on diffractive element 120. Diffractive element 120 directs light beam 160 out of the plane of optical IC 100 as shown at reference numeral 162. Prism 130 receives light beam 162 and directs it outward substantially perpendicular to the plane of optical IC 100, as shown at light beam 164. As a result of directing light beam 164 substantially perpendicular to the optical IC, there is no need to position optical fiber 156 at an angle that matches the angle of light beam 162. The same configuration and operation may be employed to direct light in the opposite direction, that is, from the optical connector 150 into the waveguide 110 of the optical IC 100.

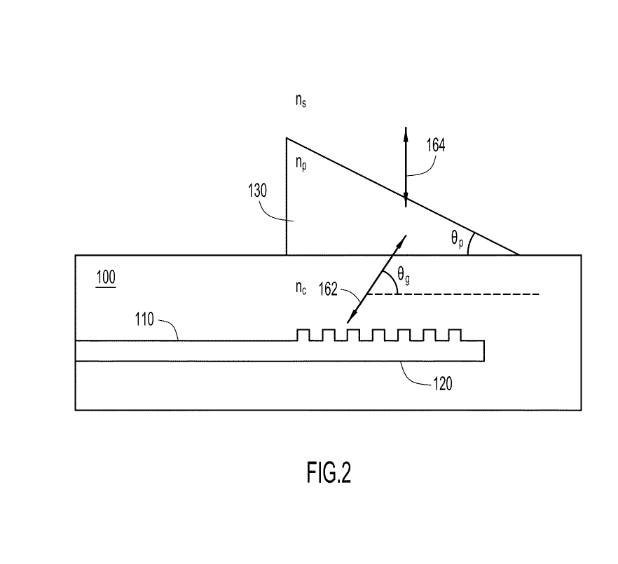

Diffractive element 120 may be a grating that is formed by adding or subtracting waveguide material in a specific periodic arrangement using, for example, complementary metal oxide semiconductor (CMOS) techniques. Light from waveguide 110 is diffracted out of the waveguide 110 at an angle that is dependent on the wavelength of the light. In one example, the spacing of the grating is tailored to the material of the waveguide and optical IC cladding surrounding the waveguide 110 in consideration of the wavelength(s) that are to be used in the optical IC. Grating 120 will generally direct light from waveguide 110 at an angle θ_{g} from the waveguide, as shown in FIG. 2.

For a case in which θ_{g} is not 90°, i.e., grating 120 does not direct light beam 162 directly perpendicular to the waveguide, prism 130 may be used to redirect light beam 162 so that light beam 164 is substantially perpendicular to the plane of IC 100. In order to make this transformation, the prism material and angle are chosen such that Snell's law is satisfied at each side of the prism. If prism 130 is a triangular prism, as shown in FIG. 2, the angle of the prism, θₚ, is given by the equation:

$${θ}_{p} - {sin}^{- 1} [ \frac{{n}_{s}}{{n}_{p}} sin {θ}_{p} ] = {sin}^{- 1} [ \frac{{n}_{c}}{{n}_{p}} cos {θ}_{g} ] ,$$

where n_{c}, nₚ, and nₛ are the indices of refraction of the cladding around the waveguide (i.e., the optical IC material), the prism, and the space around the prism (e.g., air), respectively.

Since the wavelength dependence of the diffraction from grating 120 and the refraction from prism 130 are in opposite directions (i.e., diffraction deflects long wavelengths further and refraction deflects short wavelengths further), the spreading of wavelengths from grating 120 may be counteracted by prism 130. This allows the dispersion from grating 120 to be counteracted by the dispersion of prism 130. In some cases, the two dispersions may not cancel exactly, and an error metric E may be defined across a specific range of wavelengths. The error metric may be given by the equation:

$$E = {\int }_{{λ}_{1}}^{{λ}_{2}} [ {θ}_{p} - {sin}^{- 1} ( \frac{{n}_{s}}{{n}_{p} ( λ )} sin {θ}_{p} ) - {sin}^{- 1} ( \frac{{n}_{c} ( λ )}{{n}_{p} ( λ )} cos [ {θ}_{g} ( λ ) ] ) ] d λ ,$$

where n_{c}, nₚ, and θ_{g} are all wavelength dependent, nₛ is constant (e.g., typically approximately 1 for air), and θₚ is constant with respect to wavelength. By minimizing the value of the integral, an effective configuration can be arrived at given the material constraints.

After emerging from prism 130, light beam 164 couples to optic fiber 156 in optical connector 150 through optional collection optics 154. In one example, optical connector 150 is a Multi-Path Optical (MPO) connector. Collection optics 154 may comprise one or more lenses or other optical elements configured to focus light beam 164 into the end of optical fiber 156. In this way, light beam 164 couples to a mode in optical fiber 156 and propagates off the optical IC 100.

Referring back to FIGS. 1A and 1B, in order to passively align the collection optics 154 and optical fiber 156 with light beam 164 emerging from optical IC 100, holes 140 are formed in the top surface 105 of optical IC 100 to mate with posts 158 on the optical connector 150. Once the posts 158 are mated with (inserted in) holes 140, optical connector 150 is precisely aligned with optical IC 100, such that no further alignment is necessary. Optical connector 150 may now be simply secured to optical IC 100 with, for example, epoxy or other suitable adhesive. The passive alignment from the precisely placed alignment feature eliminates any need for active optical feedback in an alignment procedure. Eliminating the equipment associated with active feedback increases the manufacturing throughput and reduces the cost of manufacturing a vertical optical interconnect.

Holes 140 may be formed using microelectromechanical systems (MEMS) techniques, such that the placement of holes 140 relative to grating 120 and/or prism 130 is possible with submicron accuracy. In another example, CMOS processing techniques may be used to achieve the submicron accuracy placement of the alignment feature (e.g., holes 140). Maintaining a placement of optical connector 150 relative to grating 120 to an accuracy of ±250 nanometers with BEOL CMOS processing allows for alignment related losses to be kept below 0.2 dB when coupling light from waveguide 110 to a single mode fiber (SMF), and vice versa. Multi-mode fibers (MMFs) will have even lower losses due to the larger width of the fiber.

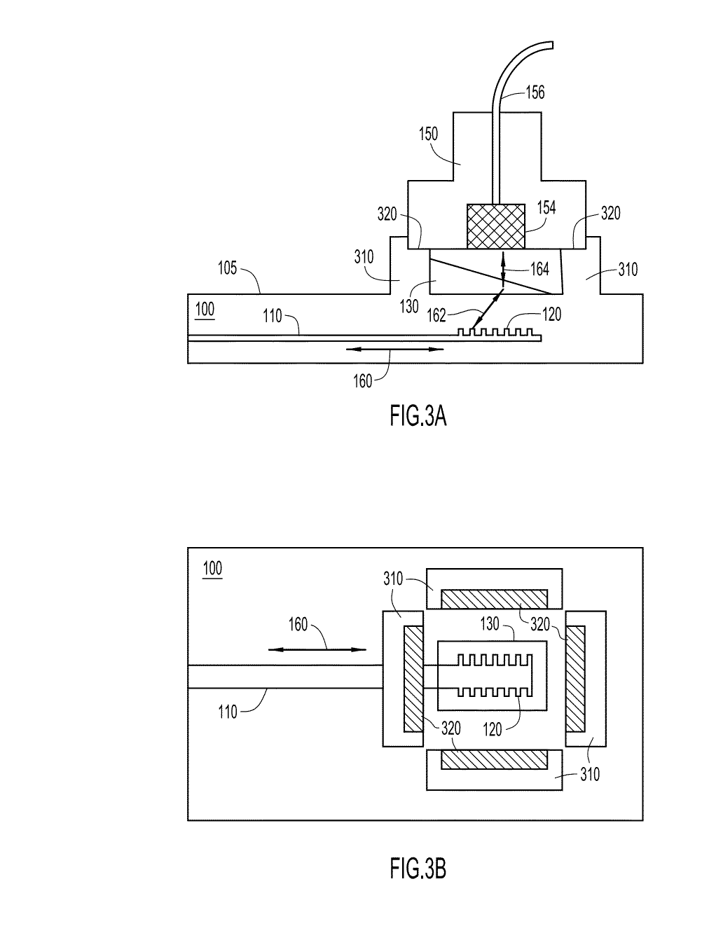

Referring now to FIGS. 3A and 3B, an example of a different type of alignment feature on optical IC 100 is shown. In this example, posts 310 are used to align optical connector 150 with grating 120, instead of the holes 140 of FIGS. 1A and 1B. Posts 310 may additionally include ledges 320 configured to mate with a surface of the housing 152 of optical connector 150. FIG. 3B shows a top view of two possible configurations of posts 310 with ledges 320, but other configurations may be fabricated to conform to different types of optical connectors.

In operation, the optical connector 150 is placed on top of the posts 310 (or ledges 320) so that a bottom surface of the housing 152 rests on the posts 310 or ledges 320. In so doing, the optical fiber 156 will be sufficiently aligned with the waveguide 110 of the optical IC 100, similar to that as explained above in connection with FIGS. 1A and 1B.

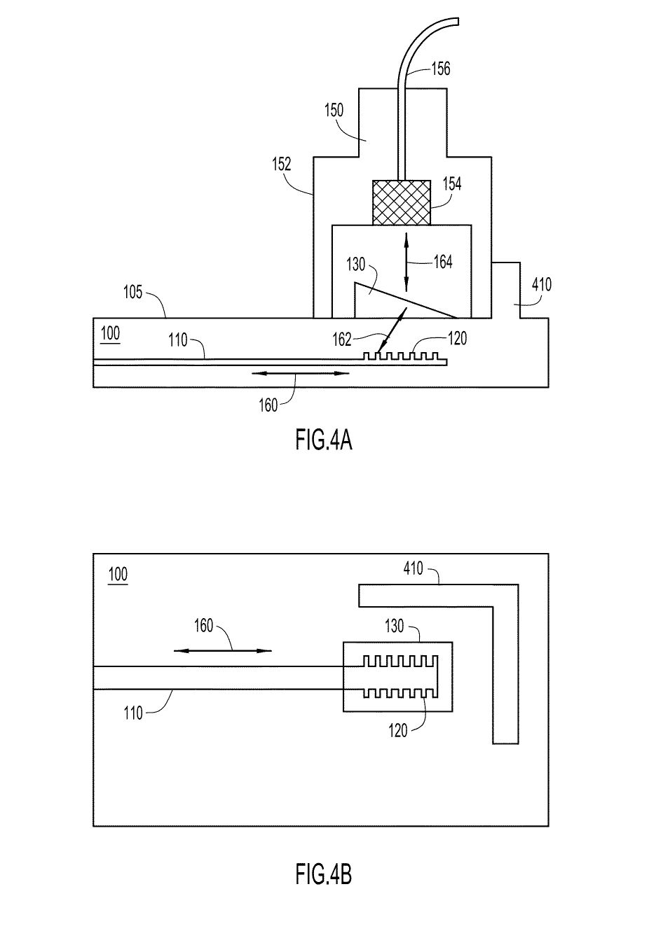

Referring now to FIGS. 4A and 4B, another example of a different type of alignment feature on optical IC 100 is shown. In this example, the alignment feature comprises walls 410 which are lithographically formed on the surface of the optical IC 100 and configured to abut the housing 152 of optical connector 150. Walls 410 are fabricated such that the connector 150 rests on the top surface 105 of optical IC 100 and, as shown in the top view of FIG. 4B, one corner of the connector 150 fits precisely into a corner in wall 410. Other configurations of walls may also be used, e.g., two opposite corner walls or four walls that abut the sides of the optical connector. The walls 410 are very precisely formed and located on the top surface 105 of the optical IC 100 in relationship to the diffraction element 120 so that the desired precise alignment between the optical fiber 156 in the optical connector 150 and the diffraction element 120 in the optical IC 100 is achieved.

While FIGS. 1A, 1B, 3A, 3B, 4A, and 4B show three different examples of alignment features, other alignment features may also comprise more than one of these three types of alignment features or structures. For example, an alignment feature may combine posts and ledges, as shown in FIGS. 3A and 3B, with holes similar to the example of FIGS. 1A and 1B fabricated in the ledges to further align and/or secure the optical connector to the optical IC.

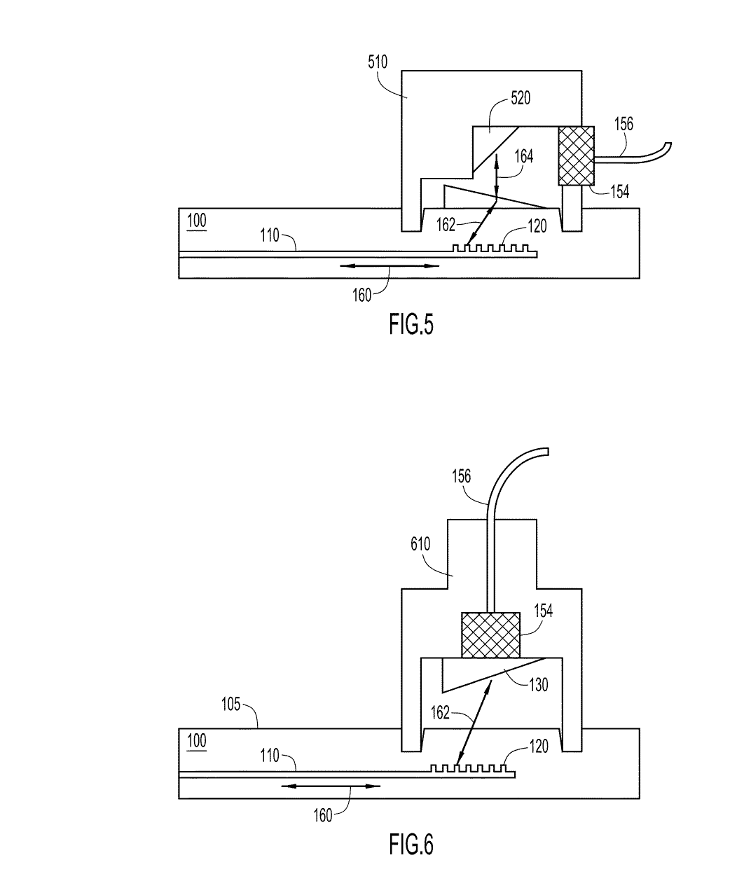

Referring now to FIG. 5, an example of a horizontally exiting fiber optic connector is shown. In this example, optical connector 510 includes optics 154 and optical fiber 156 exiting out the side of the connector housing at an orientation that is substantially parallel to the plane of the optical IC 100. In order to reflect light beam 164 toward optics 154, the optical connector 510 includes a turning mirror 520. The alignment features on optical IC 100 may be any of the alignment features described above, though the exact placement of the alignment feature may change to accommodate the different light path in connector 510 as shown in FIG. 5.

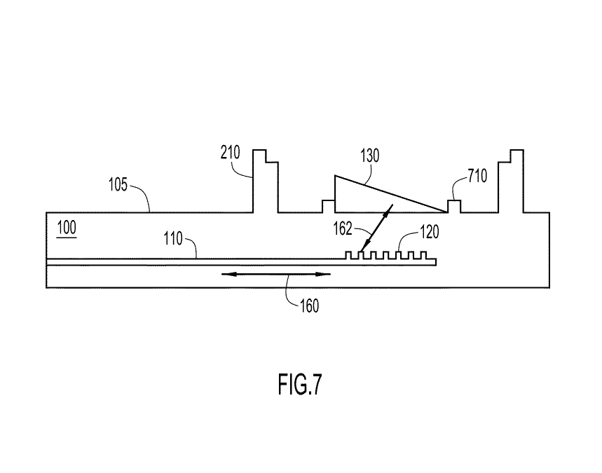

Referring now to FIG. 6, an example of an optical connector having an integrated prism is shown. In this example, optical connector 610 includes prism 130 on the surface of optics 154, instead of the prism 130 on the optical IC 100. This configuration may reduce reflections off the optics 154 that could reflect back into grating 120. Alternatively, prism 130 may be integrated into collection optics 154. Additionally, if optics 154 are not included in connector 610, the end of the optical fiber 156 may be polished at an angle to function as a prism.

Reflections between the optical IC and the optical connector may be further reduced with the inclusion of an optical isolator 155 in the optical connector (e.g., as part of optics 154) or on the optical IC. The optical isolator allows light to pass in one direction, while hindering light from propagating in the opposite direction. Additionally, anti-reflective coatings may be present on the fiber, the optical IC, and/or the prism to further reduce any back-reflections and reduce any losses associated with the back-reflections.

Referring now to FIG. 7, an example of an additional set of alignment features to align the prism is shown. In this example, walls 710 are fabricated in a similar manner to walls 410 of FIGS. 4A and 4B. However, walls 710 are placed to precisely align prism 130 instead of to precisely align the optical connector 150. Other alignment features may be used, such as holes or posts, to align prism 130 over grating 120. In another example, at least a portion of the alignment feature that is used to align optical connector 150 may also be used to align prism 130. As shown in FIG. 3A, one of the posts 310 is used as a wall to align prism 130 over grating 120, while also aligning optical connector 150.

While the examples described above refer to a single optical fiber, it should be understood that a single connector 150 may contain multiple fibers, each of which may carry signals in either or both directions, from IC 100 to fiber 156 or from fiber 156 to IC 100. Each optical path may have its own dedicated prism, or a single prism may be made large enough to span several optical paths. Alternatively, multiple connectors may mate to the same set of alignment features on IC 100. In one example, a plurality of gratings 120 may be arranged in an array on the optical IC, and the optical connector 150 comprises a plurality of optical fibers in a complementary array. The arrays of optical fibers and gratings may be precisely aligned using a single set of alignment features.

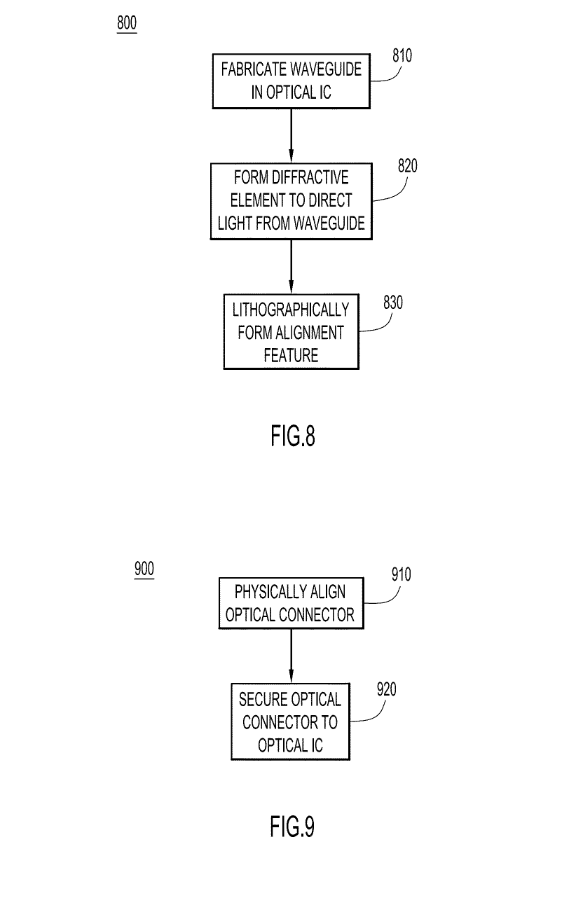

Referring now to FIG. 8, a flow chart is shown for an example process 800 of fabricating an optical IC with at least one alignment feature. In step 810, a waveguide is fabricated in an optical IC. In one example, the waveguide is fabricated by depositing a material with a lower index of refraction within a silicon wafer. The silicon wafer may include cladding for the waveguide and, in the completed optical IC, light beams will be able to propagate within this waveguide by total internal reflection. At a designated place in the waveguide, a diffractive element is formed on the waveguide in step 820. The diffractive element may be a grating formed using CMOS techniques to remove the cladding material and add waveguide material at regular intervals. In another example, the grating is formed by removing waveguide material and adding cladding material at regular intervals. The grating is sized to direct a range of wavelengths of light out of the waveguide.

In step 830, an alignment feature is lithographically formed on the optical IC. The alignment feature may be, for example, indentations, posts with ledges, walls, or any structure that is sized and placed to ensure that an optical connector is accurately aligned over the diffractive element. The alignment feature may comprise a combination of one or more of the specific types described above. The alignment feature can be placed with submicron accuracy using CMOS or MEMs fabrication techniques. In one example, the same CMOS fabrication processes that are used to create the grating may also be used to create the alignment feature. Several alignment features may be fabricated at a wafer level over several individual dies. In addition to an alignment feature to accurately place the optical connector over the grating, additional alignment features may be added to accurately position a prism with respect to the grating. The prism alignment features may be the same or different types of features, i.e., posts with ledges may be used to align the optical connector and walls may be used to align the prism. In one example, a single alignment feature is used to align the optical connector and the prism.

Reference is now made to FIG. 9. FIG. 9 shows a flow chart for a process 900 to secure an optical connector to an optical IC that includes a lithographically defined alignment feature as described in connection with any of the examples above. At 910, an optical connector is physically aligned with the grating. By placing the optical connector in physical contact with the lithographically placed alignment feature, the optical connector is precisely aligned with the grating. This allows light to be coupled between the waveguide and the optical fiber in the optical connector with low loss, and without any additional alignment steps, such as active feedback control. Once the optical connector is aligned over the grating using the alignment feature, it is secured to the optical IC in step 920. In one example, the optical connector may be secured by an adhesive or epoxy between the housing of the optical connector and the optical IC. Lithographically processing the entire wafer ensures that the surface of the optical IC is smooth and provides a pristine surface for an adhesive or epoxy to secure the optical connector. Additionally or alternatively, the optical connector may be mechanically secured to the optical IC.

In summary, the techniques presented herein permit the passive alignment of a vertical connector to a photonic chip or substrate, using alignment features lithographically defined during the fabrication of the chip. An optical grating combined with an optional prism is used to transform between light propagating horizontally in the plane of the chip, into to the vertical direction.

An apparatus is provided comprising an optical integrated circuit with a waveguide configured to propagate light. A diffractive element is configured to couple light between the waveguide and an optical connector away from the plane of the waveguide (e.g., perpendicular to the optical IC). At least one lithographically formed alignment feature is configured to physically align the optical connector with the diffractive element without the need for optical (e.g., active) feedback.

A method is provided for fabricating a waveguide in an optical circuit, and forming a diffractive element in a portion of the waveguide to couple light between the waveguide and an optical connector. At least one alignment feature is lithographically formed in a predetermined relationship/position with respect to the diffractive element. The alignment feature is configured to passively align the optical connector with the diffractive element without the need for optical (e.g., active) feedback.

A method is further provided for physically aligning an optical connector, without use of optical feedback. The optical connector is physically aligned with at least one alignment feature lithographically formed on an optical integrated circuit with respect to a diffractive element on a waveguide of the optical integrated circuit. After the optical connector is passively aligned, the optical connector is secured (e.g., with epoxy/adhesive) to the optical integrated circuit so that light can be coupled between the waveguide in the optical integrated circuit and the optical connector, through the diffractive element.

The above description is intended by way of example only. Various modifications and structural changes may be made therein without departing from the scope of the concepts described herein and within the scope and range of equivalents of the claims.

What is claimed is:

1. An apparatus comprising:
an optical integrated circuit;
a waveguide in the optical integrated circuit configured to propagate light;
a diffractive element configured to couple light between the waveguide and an optical connector away from a plane of the waveguide; and
at least one alignment feature lithographically formed in the optical integrated circuit with respect to the diffractive element, the alignment feature configured to physically align the optical connector with the diffractive element without need for optical feedback.

2. The apparatus of claim 1, wherein the at least one alignment feature comprises a plurality of indentations or trenches in a surface of the optical integrated circuit.

3. The apparatus of claim 1, wherein the at least one alignment feature comprises a plurality of raised structures extending above a surface of the optical integrated circuit, the raised structures configured to support the optical connector above a surface of the integrated circuit.

4. The apparatus of claim 3, further comprising at least one ledge in the plurality of raised structures, the ledge having a shape configured to support an edge of the optical connector.

5. The apparatus of claim 1, wherein the at least one alignment feature extends above a surface of the optical integrated circuit and is configured to abut an edge of the optical connector such that the optical connector rests on the surface of the optical integrated circuit against the at least one alignment feature.

6. The apparatus of claim 1, further comprising a refractive element between the diffractive element and the optical connector, the refractive element configured to redirect light from the diffractive element in a direction that is substantially perpendicular to the plane of the optical integrated circuit.

7. The apparatus of claim 6, wherein the refractive element is configured to redirect the light from the diffractive element to counteract dispersion across a range of wavelengths of the light from the diffractive element.

8. The apparatus of claim 7, wherein the refractive element comprises a right triangular prism, and the dispersion from the diffractive element is counteracted by minimizing an error metric E defined by:
$$E = {\int }_{{λ}_{1}}^{{λ}_{2}} [ {θ}_{p} - {sin}^{- 1} ( \frac{{n}_{s}}{{n}_{p} ( λ )} sin {θ}_{p} ) - {sin}^{- 1} ( \frac{{n}_{c} ( λ )}{{n}_{p} ( λ )} cos [ {θ}_{g} ( λ ) ] ) ] d λ ,$$
wherein λ₁ and λ₂ define the range of wavelengths, θ_{g}(λ) is an angle that the diffractive element redirects the light from the waveguide with respect to the plane of the substrate as a function of wavelength, nₚ(λ) is an index of refraction of the prism as a function of wavelength, n_{c}(λ) is an index of refraction of a cladding around the waveguide of the optical IC as a function of wavelength, θₚ is a prism angle, and nₛ is an index of refraction of a medium surrounding the prism.

9. The apparatus of claim 6, wherein the refractive element is positioned with respect to the alignment feature, and the alignment feature is configured to physically align the refractive element and the optical connector.

10. The apparatus of claim 6, wherein the refractive element is positioned with respect to at least one other alignment feature, the other alignment feature configured to physically align the refractive element with the diffractive element.

11. The apparatus of claim 1, further comprising an optical isolator positioned between the optical connector and the diffractive element.

12. The apparatus of claim 1, wherein the alignment feature is configured to physically align the optical connector to a position in which light from the waveguide is coupled to an optical fiber in the optical connector with less than 0.2 dB loss.

13. In combination, the apparatus of claim 1 and the optical connector, wherein the optical connector includes a refractive element on a surface of the optical connector facing the diffractive element, wherein the refractive element is configured to redirect light from the diffractive element in a direction that is substantially perpendicular the surface of the optical connector.

14. In combination, the apparatus of claim 1 and the optical connector, wherein the optical integrated circuit includes a silicon photonic circuit having a plurality of diffractive gratings, and wherein the optical connector includes a plurality of optical fibers physically aligned with the plurality of diffractive gratings.

15. A method comprising:
physically aligning an optical connector, without use of optical feedback, with at least one alignment feature lithographically formed on an optical integrated circuit with respect to a diffractive element on a waveguide of the optical integrated circuit; and
securing the optical connector to the optical integrated circuit so that light can be coupled between the waveguide in the optical integrated circuit and the optical connector, through the diffractive element.

16. The method of claim 15, further comprising placing a refractive element between the diffractive element and the optical connector to counteract dispersion across a range of wavelengths in the light from the diffractive element.

17. The method of claim 16, wherein placing the refractive element comprises physically aligning the refractive element with the diffractive element using at least one other alignment feature lithographically formed on the optical integrated circuit.

18. A method comprising:
fabricating a waveguide in an optical circuit;
forming a diffractive element in a portion of the waveguide to couple light between the waveguide and an optical connector; and
lithographically forming at least one alignment feature in the optical integrated circuit with respect to the diffractive element, the at least one alignment feature configured to passively align the optical connector with the diffractive element without need for optical feedback.

19. The method of claim 18, wherein lithographically forming the at least one alignment feature comprises etching a plurality of indentations or trenches.

20. The method of claim 18, wherein lithographically forming the alignment feature comprises using complementary metal oxide semiconductor (CMOS) techniques to form a plurality of raised structures extending above a top surface of the photonic integrated circuit.

21. The method of claim 20, wherein forming the diffractive element comprises using the CMOS techniques to form a grating in the waveguide.

22. The method of claim 18, further comprising lithographically forming at least one other alignment feature that is used to align a refractive element with the diffractive element.
